(19) United States
(12) Patent Application Publication
(10) Pub. No.: US 2002/0079611 A1
(43) Pub. Date: Jun. 27, 2002

(54) Process and apparatus for preparing a molded article

(76) Inventors: Thomas M. Ellison, Fort Mill, SC (US); Arthur K. Delusky, Detroit, MI (US); Stephen P. McCarthy, Tyngsboro, MA (US)

Correspondence Address: Bachman & LaPointe, P.C., Suite 1201, 900 Chapel Street, New Haven, CT, 06510-2802, US

(21) Appl. No.: 09/749,344

(22) Filed: Dec. 27, 2000

(51) Int. Cl. B29C 43/20

(52) U.S. Cl. 264/247; 264/266; 264/278; 425/127; 425/129.1

(57) ABSTRACT

A film is placed over a mold cavity extending over the mold cavity rim. The film is held in place over the mold cavity by a frame member which engages the film adjacent the mold cavity rim. The frame is magnetically secured in place over the mold cavity rim to hold the film over the mold cavity rim. Molten plastic is provided over the film and the film and plastic is formed into a molded article having the shape of the mold cavity.

### BACKGROUND OF THE INVENTION

In accordance with U.S. Pat. No. 5,401,457 for PROCESS FOR FORMING A COLOR COATED ARTICLE, By Emery I. Valyi, Patented Mar. 28, 1995, a process is provided for forming a color coated article. In accordance with the '457 patent, a film is placed substantially flat over a mold cavity and deformed by a core mold half and by molten plastic entering through a sprue.

An alternate method consists of thermoforming the film to nest accurately in the mold cavity, with said operation being carried out independently of the mold. The formed film insert is then brought to the mold and placed into the cavity. This procedure is described by Ch. Fridley, Avery Dennison, in Product Finishing, Apr. 19, 1992, and European Patent 0,442,128 to Beyer, and other publications. The Avery procedure entails a forming process of the film that is well known and widely practiced for other uses. It is a low pressure process for shaping the film or sheet, in solid condition, at relatively low temperatures. This holds for all of the several variants of thermoforming, such as vacuum forming, whether the vacuum is to suck the film into the cavity, or onto the core, as well as thermoforming followed by a sizing operation.

The result of this is a product whose dimensional accuracy and shape conformance is not within the range of a high pressure forming process, such as injection molding or compression molding. Consequently, the thermoformed preform, while nesting in the mold cavity or slipped over the core, fails to conform to them fully. Thus, upon injecting or compressing plastic behind the preform, the preform will deform producing localized surface imperfections. These imperfections may be dimensionally insignificant but optically discernible and therefore may provide a product of insufficient quality for an automotive finish, for example. In addition, the cost of a separately made film insert is relatively high, considerable trim scrap is generated, and the handling (transport, destacking, insertion) become expensive.

The procedure of the '457 patent overcomes the above defects; however, it is difficult to control, particularly when molding parts with large surfaces and sharply varying curvature. The difficulties increase when the plastic is pressure molded at high enough temperatures to reduce the film strength substantially, as in the case of conventional injection molding.

In applying either of the above processes to large, panel-like structures, it was found, moreover, that the procedure of injection molding of the '457 patent and Avery Dennison procedure referred to above, is difficult to carry out, requiring extremely costly equipment, and prone to produce imperfections at the interface between the film layer and the injected plastic.

In accordance with U.S. patent application Ser. No. 09/130,864, filed Aug. 7, 1998, by Emery I. Valyi et al., a color coated article is prepared by depositing molten plastic on a film and forming the film-molten plastic combination in a mold cavity. This procedure and the resultant article effectively and efficiently forms a color coated article. However, it would be particularly desirable to further improve the process and apparatus for preparing a molded article, particularly a color coated article.

Accordingly, it is a principal object of the present invention to provide a process and apparatus which conveniently and expeditiously forms a molded article from molten plastic and a film insert, wherein the film is the outer layer of the molded article and wherein desirably the film is colored.

It is a further object of the present invention to provide a process and apparatus as aforesaid which overcomes the foregoing defects and provides a commercially feasible process and apparatus for forming a color coated article.

It is a still further object of the present invention to provide a process and apparatus as aforesaid which is operative under conditions that are sufficiently controllable and cost efficient to produce complex parts or large parts as those of a size of major body components of passenger cars.

Further objects and advantages of the present invention will appear hereinbelow.

### SUMMARY OF THE INVENTION

The present invention includes a process for preparing a molded article, which comprises: providing a mold cavity having a mold cavity rim; placing at least one film over said mold cavity extending over said mold cavity rim; holding the film in place over said mold cavity by a frame member which engages the film adjacent the mold cavity rim; magnetically securing the frame in place over the mold cavity rim to hold the film over the mold cavity; and providing molten plastic over the film and forming the film and molten plastic in the mold cavity into a molded article having the shape of the mold cavity, wherein the film is an outer layer of the molded article.

Desirably, the molten plastic is deposited on the film to form a combination of a film with molten plastic thereon. The film and molten plastic are preferably formed into the shape of the mold cavity at least in part by a mold core which forms the film and molten plastic into the shape of the mold cavity.

In a preferred embodiment, the frame is fitted with magnets in registry with magnets on the mold cavity rim. Desirably, one of the frame and mold cavity rim is fitted with at least one ferromagnetic metal insert in registry with at least one electromagnet in the other of said frame and rim. Thus, the film is held in place by clamping pressure and the electromagnet enables one to easily and conveniently reduce the clamping pressure during the forming step by controlling and varying the clamping force electrically as desired during the molding cycle. Alternatively, a permanent magnet may be used in place of an electromagnet. The clamping force of the permanent magnet is controlled and varied by electrical current to deactivate the magnetic force. A further embodiment is to use magnetically controlled rollers or pins to engage the film and to control the film tension and release during the mold closing step. In this manner the film is allowed to move under the clamp into the cavity in a predetermined controlled manner so as to minimize film thinning and wrinkling in the molded part.

The film may desirably be colored to form a color coated molded article.

The present invention also provides an apparatus for preparing a molded article. The apparatus comprises: a mold cavity having a mold cavity rim; a frame member for holding at least one film in place over said mold cavity by engaging the film adjacent the mold cavity rim; means for magnetically securing the frame in place over the mold cavity rim to hold the film in place over the mold cavity; and means for providing molten plastic over the film, and means for forming the film and molten plastic in the mold cavity into a molded article having the shape of the mold cavity, wherein the film is an outer layer of the molded article.

Further specific features and advantages of the present invention will appear hereinbelow.

### BRIEF DESCRIPTION OF THE DRAWINGS

The present invention will be more readily understood from a consideration of the following drawings, wherein:

FIG. 1 is a partly schematic view showing one embodiment of the process and apparatus for forming a molded article in accordance with the present invention;

FIG. 2 is a top view of an embodiment of a frame member;

FIG. 3 is a top view of an embodiment of a mold cavity;

FIGS. 4 and 5 are partial sectional views of representative molded articles prepared in accordance with the present invention; and

FIG. 6 shows an alternate embodiment for forming a molded article in accordance with the present invention.

### DETAILED DESCRIPTION OF PREFERRED EMBODIMENTS

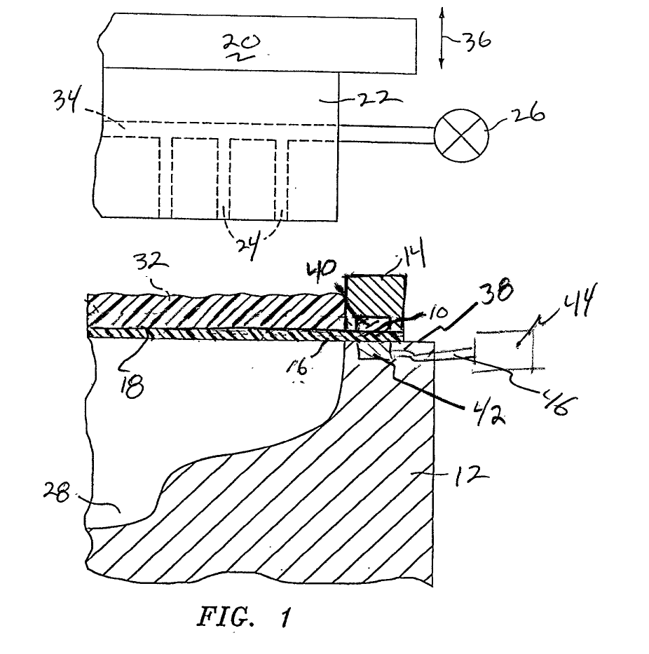

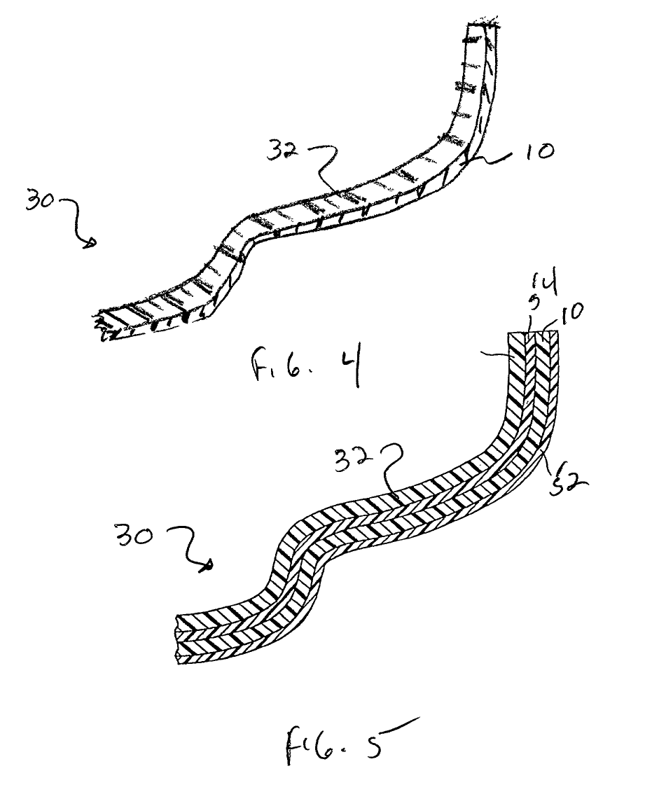

In accordance with the illustrative embodiment of FIG. 1, film or blank 10 is held over mold 12 by clamping frame 14. Outer face 16 of film 10 is opposed to the inner face 18 of film 10 and forms the external surface of the film or blank 10 in the embodiment of FIG. 1, and also forms the outer face of the final molded article. Platen 20 is shown with a forming mandrel 22, which is desirably a solid metal mandrel but which may also for example be an elastomeric mandrel, and which may contain air slots 24 and pressure control means 26 connected thereto. Mold 12 includes mold cavity 28 therein which forms the shape of the desired resultant molded article 30 shown in FIG. 4. Naturally, any desired mold cavity shape may be used. In addition, if desired, one could texture the mold surface to have a desired textured finish on the final product. Hot plastic 32 is injected or deposited on the film 10 by any desired means, as from an extruder, to form the layered structure shown in FIG. 1. As shown in the embodiment of FIG. 1, slots 24 if used intersect a manifold slot 34 which is connected to a source of fluid pressure.

In operation, the mandrel 22 enters the clamping frame 14. Pressure air is applied to slots 24 if used expanding the slots into passages. Thereby, pressure is applied to the deposited plastic 32 and the film 10 combination. Pressure may also be present in mold cavity 28 to support the layers over the mold before molding, as by air slots in mold 12 (not shown), which should be controllably released at the same time as the layers are formed into the mold cavity. This will result in forming the layers by molding into the molded article shown in FIG. 4. The mandrel 22 moves simultaneously downward into the mold cavity 28 in the direction of arrow 36. As the plastic and film reach the mold surface, the mandrel continues and conforms to the surface of the plastic away from the film 10 layer, and continued pressure by the platen results in forming of the final desired article, as shown in FIG. 4. The mandrel and mold are preferably cooled. If a solid mandrel is used, it should conform to the desired shape of the final article. If desired, the film may first be conformed to the shape of mold cavity 28, mandrel 22 seated in mold 12 and plastic material 32 injected against the film to form the final article.

If desired, a multilayered film may be used rather than a single film layer. Thus, for example, if a single film layer is used, it is desirably colored based on requirements for the final molded product. If a multilayered film is employed one may employ an inner reinforcing layer or other inner layers based on product requirements.

The resultant molded article 30 includes the outer film layer 10, which is desirably a colored layer, and the inner plastic layer 32. The resultant molded article 30 has the desired shaped configuration determined by the shape of the mold cavity. Moreover, advantageously, despite the forming operation the colored layer is characterized by color uniformity and a color coated article is formed in a simple and convenient manner.

In accordance with the present invention, frame 14 is magnetically secured in place over mold cavity rim 38 to securely hold film 10 in place over mold cavity 28. In a preferred embodiment at least one ferromagnetic insert 40 is fitted into the frame member 14 in registry with at least one electromagnet 42 in mold cavity rim 38. The electromagnet is connected to a power source 44 via conductors 46.

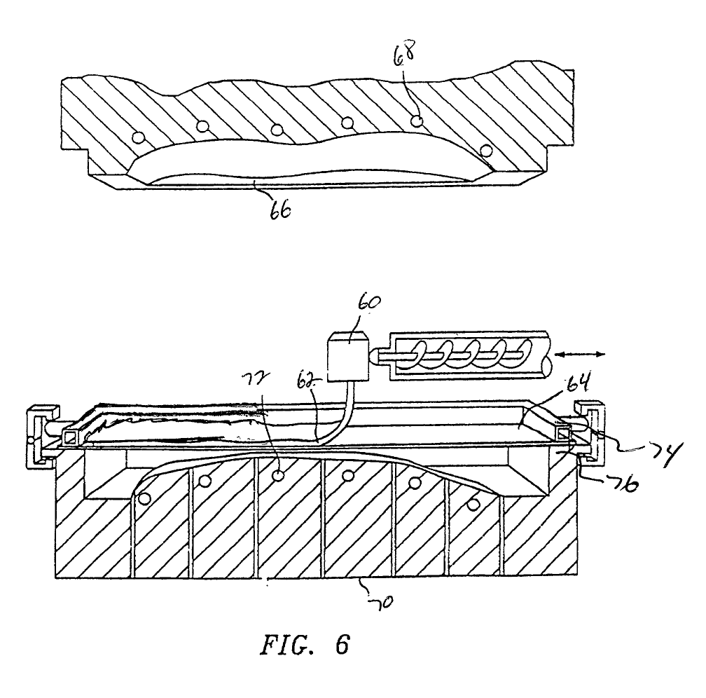

In accordance with the embodiment of FIG. 6, a traversing extruder 60 extrudes a molten plastic layer 62 onto film 64. Extruder 60 is movable from a position above film 64 as shown in FIG. 6 to a position spaced from film 64 to permit engagement of core half 66 with the film-molten plastic combination. Core half 66 desirably contains cooling channels 68, and mold 70 also desirably contains cooling channels 72. Naturally, frame 74 is magnetically secured in place over mold cavity rim 76 to hold the film in place as in FIG. 1.

Advantageously, the strength of the clamping force by frame 14 against film 10 may be varied electrically as desired in the molding cycle. For example, the clamping force can be maximum as the core engages the film and then reduced as the mold continues to close to allow film slippage as desired and to the desired extent.

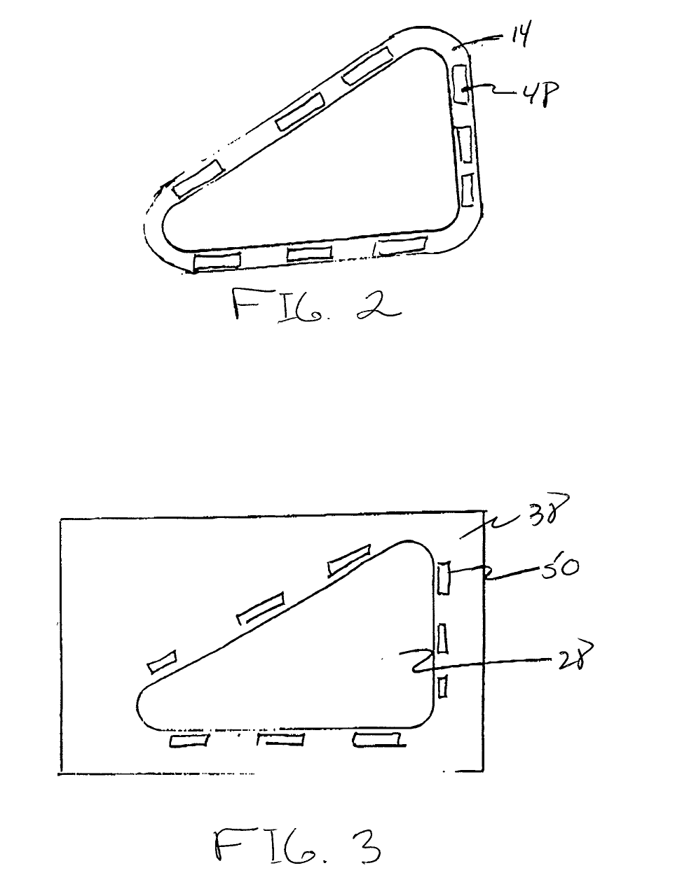

Alternatively, as shown in FIGS. 2 and 3, frame member 14 may be fitted with magnets 48 in registry with magnets 50 on cavity rim 38 so that the frame is magnetically firmly secured in place over the mold cavity.

The blank or film 10 is plastic, and any desired plastic material may be used for the blank 10 or molten plastic material 32, for example, polyolefins, polyurethanes, acrylic polymers, acrylonitrile budadiene styrene (ABS), polyvinyl chloride, polystyrene, polycarbonates, polyesters, etc., and desirable blends of the foregoing. The colored layer may be directly coated on the film or blank or may be a separate layer as a colored plastic layer. Thus, for example, as shown in FIG. 5, molded article 30 may include film 10, outside colored film layer 52 and inside reinforcing layer 54, with innermost plastic layer 32. Naturally, many variations on the foregoing may be employed based on particular requirements, as for example simply providing an outer colored film layer, a central reinforcing layer and the innermost plastic layer.

Layers 10 and 32 may be the same or different materials. If the same materials are used, one can obtain melt bonding between the materials. If different materials are used, one can achieve a mechanical bond into fibers of the reinforcing material, or adhesive bonding can be used. The layers may be cut or stamped from a web and a supply having the size and shape to fit over or into the mold cavity maintained adjacent the mold for transfer to the mold as needed and the colored layer coated on the film. The depth of color on the colored layer may be varied to at least partially accommodate thinning during processing and to at least partially adjust the color depth to the amount of deformation any given portion will undergo.

The film and/or colored layer may be applied to the mold with robot means or removably adhered to a carrier film strip. The carrier film strip may be provided with means to register the position of the colored blanks relative to the mold half onto which the blanks are to be placed, e.g., edge perforations. The carrier, with the blanks attached, may then be supplied from a roll. Once the blank and mold are juxtaposed, suction is applied to the edge of the blank by the mold, as through channels, sufficient to separate the blank from the carrier strip. Naturally, other transfer means may readily be used.

Naturally, any other convenient or desirable plastic delivery means or molding procedure may conveniently be used while still retaining the advantages of the present invention, as for example alternative compression molding techniques, injection molding or injection blow molding.

Similarly, multiple plastic layers may be deposited on the film or film layers. Alternatively, one polymer could be deposited in a designed pattern, and a second or a plurality of second polymers deposited in a designed pattern. This could be done with one or more extruders feeding for example separate channels to deposit a predesigned pattern of multiple resins. As a further alternative, one could sequentially feed polymers of different characteristics to provide designed properties in the finished product.

It is a significant advantage of the present invention to enable one to conveniently and expeditiously form molded products with a high degree of control in the molding procedure. The film and/or film layers may be firmly held as desired, with the ability to controllably release holding or clamping pressure as needed.

While the foregoing procedure is aimed primarily at application in the exterior of vehicles, it should be noted that there are many other types of components that would benefit from the subject process of molding, as compression molding, with a colored finish and with an accurately molded article, particularly for large household appliances and architectural components. The foregoing produces improved final product, particularly large, panel-like thick parts and eliminates or reduces color thinning and degradation of the film coating. The present invention is useful with any plastic film since it avoids local degradation or thinning of the plastic film.

As a further alternative, one can use co-extrusion for the molten plastic. Plastic from a die may be extruded in co-layers or in multiple passes from two heads to deposit different polymers and/or compositions and/or fillers. Alternatively, the molten plastic may be applied directly to the core.

As a still further alternative, one may employ a variety of types of films, as a conductive film (EMI-RFI), a film with UV and/or infrared absorption characteristics, or any desired and convenient film with desired range of properties to achieve particular results.

The particular configuration of the frame member is not especially critical. The frame member should firm hold the film or multiple layers in place during the magnetic securing procedure. The frame may be a single continuous member, an assembly of members or a set of members.

It is to be understood that the invention is not limited to the illustrations described and shown herein, which are deemed to be merely illustrative of the best modes of carrying out the invention, and which are susceptible of modification of form, size, arrangement of parts and details of operation. The invention rather is intended to encompass all such modifications which are within its spirit and scope as defined by the claims.

What is claimed is:

1. Process for preparing a molded article, which comprises:
providing a mold cavity having a mold cavity rim;
placing at least one film over said mold cavity extending over said mold cavity rim;
holding said film in place over said mold cavity by a frame member which engages the film adjacent the mold cavity rim;
magnetically securing the frame in place over the mold cavity rim to hold the film over the mold cavity; and
providing molten plastic over the film, and forming the film and molten plastic in said mold cavity into a molded article having the shape of the mold cavity, wherein the film is an outer layer of the molded article.

2. Process according to claim 1, wherein the molten plastic is deposited on said film to form a combination of a film with molten plastic thereon.

3. Process according to claim 1, wherein the film and molten plastic are formed into the shape of said mold cavity at least in part by a mold core which forms the film and molten plastic into the shape of the mold cavity.

4. Process according to claim 1, including fitting the frame with magnets in registry with magnets on said mold cavity rim.

5. Process according to claim 1, wherein one of the frame and mold cavity rim is fitted with at least one ferromagnetic metal insert in registry with one of (1) at least one electromagnet and (2) an electrically deactivated permanent magnet in the other of said frame and mold cavity rim.

6. Process according to claim 5, wherein the frame holds the film in place by clamping pressure, and wherein the clamping pressure is reduced during said forming step.

7. Process according to claim 1, including providing a colored film to form a color coated molded article.

8. Process according to claim 1, including the step of providing a multilayered film over said mold.

9. Apparatus for preparing a molded article, which comprises:
a mold cavity having a mold cavity rim;
a frame member for holding at least one film in place over said mold cavity by engaging the film adjacent the mold cavity rim;
means for magnetically securing the frame in place over the mold cavity rim to hold the film in place over the mold cavity; and
means for providing molten plastic over the film, and means for forming the film and molten plastic in the mold cavity into a molded article having the shape of the mold cavity, wherein the film is an outer layer of the molded article.

10. Apparatus according to claim 9, including means for depositing molten plastic on said film to form a combination of a film with molten plastic thereon.

11. Apparatus according to claim 9, including a mold core which at least in part forms the film and molten plastic into the shape of the mold cavity.

12. Apparatus according to claim 9, including magnets in the frame in registry with magnets on the mold cavity rim.

13. Apparatus according to claim 9, including at least one ferromagnetic metal insert in one of the frame and mold cavity rim, and one of (1) at least one electromagnet and (2) an electrically deactivated permanent magnet in the other of said frame and mold cavity rim.

14. Apparatus according to claim 13, wherein the frame holds the film in place by clamping pressure, and including means for reducing clamping pressure during forming.

15. Apparatus according to claim 9, wherein said film is a colored film to form a color coated molded article.

16. Apparatus according to claim 9, wherein said film is multilayered.
